(19) United States
(12) Patent Application Publication
(10) Pub. No.: US 2013/0278607 A1
(43) Pub. Date: Oct. 24, 2013

(54) Systems and Methods for Displaying Animations on a Mobile Device

(71) Applicant: A Thinking Ape Technologies, Vancouver (CA)

(72) Inventors: John Twigg, Vancouver (CA); Murat Ayfer, Vancouver (CA); Jim Slemin, Burnaby (CA); Tyler Schroeder, Surrey (CA)

(21) Appl. No.: 13/841,714

(22) Filed: Mar. 15, 2013

Related U.S. Application Data
(60) Provisional application No. 61/636,584, filed on Apr. 20, 2012.

(51) Int. Cl. G06T 13/80

(52) U.S. Cl. CPC G06T 13/80
USPC 345/473

(57) ABSTRACT

The invention provides for systems, devices, and methods for displaying animations on devices with low-memory capacity or low-processing power, such as a mobile device. Animation sequences can by created using scene graphs of nodes. Nodes can be embedded nodes, collection nodes, or image nodes. Embedded nodes can be an embedded scene graph, a collection node can be a collection of nodes that reference collection of image sets, and an image node can be a reference to an image file and an affine transformation. Image sequences can be used using affine transformations. The affine transformation matrices can then be exported to an animation data file. Inclusion of affine transformation matrices with animation data files can reduce the memory required to store multiple image files and can reduce the computation power required to display animations. The systems, devices, and methods for displaying animations can allow for a high degree of creative freedom while reducing memory and processing requirements on a client device.

### CROSS-REFERENCE

This application claims the benefit of U.S. Provisional Application No. 61/636,584, filed Apr. 20, 2012, which application is incorporated herein by reference in its entirety.

### BACKGROUND OF THE INVENTION

There are a variety of existing systems and methods for displaying 2D animations on a device. One traditional 2D animation techniques includes creating multiple images, storing each image in memory, and then displaying the images sequentially to create an animation. While this traditional technique allows for specific control over each image frame, and therefore, allows a wide degree of freedom. However, because each image is stored in memory, this traditional animation technique requires significant memory storage capacity. Furthermore, additions or modifications to an existing animation will require additional image frames to be created, which may require significant amount of time for an artist to draw. An example of a traditional sequential animation sequence in shown in FIG. 1. As shown in FIG. 1, frames are pre-rendered and stored as individual images (e.g., Image1, Image2, Image3, and Image4). The frames are displayed sequentially at a specified rate to render an animation on a target platform.

The use of armature systems in animations provides an alternative that addresses some of the deficiencies of traditional animation systems. Armature or skeletal systems typically are used for objects that can be composed of several interconnected parts. The objects are created by creating a rigging onto which multiple parts are mapped. The parts are represented by images or sometime meshes. Objects are animated by manipulating the rigging, and frames of an animation are created from calculations of how the various parts should be displayed based on the manipulated riggings. The calculations required to form each new image can be taxing on a device, and there are inherent limitations in how much each part can be modified during an animation. The animation sequences are limited by the skeletal model. Simplistic skeleton models can create animations that look artificial or inaccurate. Complex skeletons can result in more accurate animations at the expense of increased processing power requirements. The limited degrees of freedom for modifying the objects can make animations seem mechanical and inaccurate.

An example of an animation sequence utilizing an armature system is shown in FIG. 2 and FIG. 3. The animation sequence is created using a armature or skeletal model of a human body that allows for multiple individual objects (e.g., the head, hands, arms, torso, legs, and feet) to be interrelated. The relationship of one object to other objects (such as the torso to the head) can be designed such that new frames can be created by providing instructions on how the skeleton should be moved. This can allow for the creation of dynamic animations without an artist having to draw new frames because the rendering system can calculate how the object should be displayed without having to pre-store the image of each frame. For example, an animator can have the animated human body move his arm upward by providing instructions for an arm to raise upward rather than having to draw new images with the arm sequentially moving upward. While this can result in memory savings because new images for each step are not stored, there is an increase in the amount of processing power required to display the animation because the rendering platform must perform calculations. Also, taking in FIG. 2 and FIG. 3 as an example, animations requiring fine tuned movement, such as movement in the fingers or face would not be possible because the skeleton lack sufficient detail.

Therefore, there is a need for improved systems and methods for displaying animations on devices with low-memory capacity or low-processing power, such as a mobile device.

### SUMMARY OF THE INVENTION

The present invention generally relates to the display of animations on a device. The device can have low memory capacity and/or low processing power, such as a mobile device. The animations can be 2D animations, where the animations are of objects that lack perspective. The present invention can allow for optimized animations to be displayed on a mobile device that require less memory and less processing power as compared to animations created using traditional animation techniques. The process of creating an animation for export can include the generation of one or more affine transformations. The affine transformations can be saved and exported in an animation data file. The affine transformations in the animation data files can be interpreted by a runtime engine that transforms one or more parts of the animation to create an animation sequence. In some embodiments, the animation can incorporate metadata that can be processed at the time of animation export, or by a runtime engine that modifies the animation based on the metadata.

In one aspect, the invention provides for a machine implemented method for displaying a two-dimensional animation sequence on a mobile device comprising: creating the animation sequence comprising a plurality of nodes and metadata, wherein each node of the plurality of nodes is an image node, an embedded node, or a collection node, and wherein each image node of the plurality of nodes further comprises an affine transform matrix a reference to an image file.

In some embodiments, the machine implemented method further comprises creating an animation data file that comprises hierarchy data, collection data, and animation data, wherein the hierarchy data comprises a scene graph of the plurality of nodes, wherein the collection data comprises collection node data having a plurality of animation sets, and wherein the animation data comprises image node data.

In another aspect, the invention provides for a method for displaying a two-dimensional animation sequence on a mobile device comprising: creating the animation sequence comprising a scene graph of a plurality of nodes using Adobe Flash Professional, wherein each node of the plurality of nodes is an image node, an embedded node, or a collection node; extracting hierarchy data, collection data, and animation data from the scene graph; and saving the hierarchy data, the collection data, and the animation data to an animation data file. The plurality of nodes and/or any associated metadata can be stored in memory, such as in the memory of the authoring platform or in the memory of the rendering platform.

In yet another aspect, the invention provides for a machine implemented method for displaying a two-dimensional animation sequence on a mobile device comprising: creating a sequence of images comprising a plurality of first images and plurality of second images that are affine transformations of the first images; calculating a plurality of affine transformation matrices between the plurality of first images and the plurality of second images that are affine transformations of the first images; exporting references to the plurality of first images and the affine transformation matrices to an animation data file; and creating a sprite sheet comprising the plurality of first images, wherein the sprite sheet excludes duplicate first images.

The animation represented by a series of afine transforms and textures can be further preprocessed into a series of vertices. Vertices or vertex arrays can be a data format used directly by graphics cards to render images to the screen in what is often called a graphics pipeline.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawing(s) of which:

FIG. 1 is a depiction of a traditional animation technique.

FIG. 2 is a depiction of an armature model.

FIG. 3 is a depiction of an armature model.

FIG. 4 is a depiction of a process for creating and displaying an animation on a device.

FIG. 5 is a depiction of a scene graph.

FIG. 6 is a depiction of a composition of parts.

FIG. 7 is a depiction of individual parts that make up a composition.

FIG. 8 is a depiction of a composition of parts, showing an outline of each individual part and a metadata tag.

FIG. 9 is a depiction of a frame of an animation sequence.

FIG. 10 is a depiction of a frame of an animation sequence.

FIG. 11 is a depiction of a frame of an animation sequence.

FIG. 12 is a depiction of a frame of an animation sequence.

FIG. 13 is a depiction of an interpolation process that creates affine transforms.

FIG. 14 is a depiction of an export process that creates an animation data file.

FIG. 15 is a depiction of a merging process that merges multiple exported animation data files to single animation data file.

FIG. 16 is a depiction of a process for creating sprite sheets.

FIG. 17 is a depiction of exemplary part combinations that can be used to create male faces.

FIG. 18 is a depiction of exemplary part combinations that can be used to create female faces.

FIG. 19 is a depiction of a traditional animation sprite sheet.

FIG. 20 is a depiction of a sprite sheet having multiple parts.

FIG. 21 shows an example of an animation section of an animation data file.

FIG. 22 shows an example of a collection section of an animation data file.

FIG. 23 shows an example of a hierarchy section of an animation data file.

FIG. 24 is a depiction of a device for displaying an animation sequence.

FIG. 25 is a depiction of a system for displaying animations.

FIG. 26 shows part 1 of an animation data file.

FIG. 27 shows part 2 of an animation data file.

FIG. 28 shows part 3 of an animation data file.

FIG. 29 shows part 4 of an animation data file.

FIG. 30 shows part 5 of an animation data file.

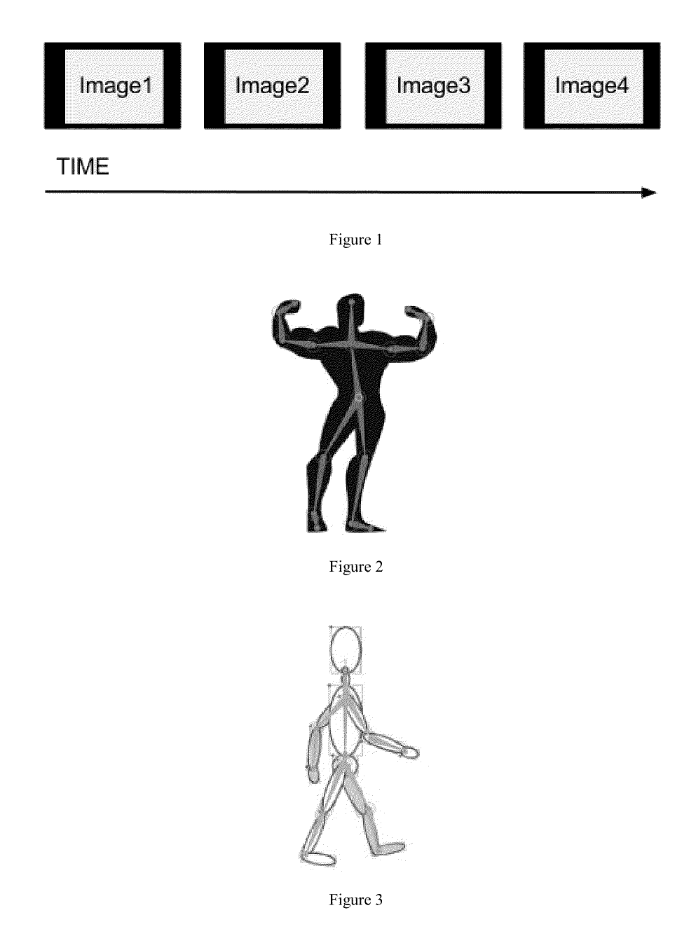

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein can be employed in practicing the invention. It shall be understood that different aspects of the invention can be appreciated individually, collectively, or in combination with each other.

The invention provides for systems, devices, and methods for displaying animations on a device, such as a device with low-memory capacity and/or low-processing capacity. An exemplary device could be a mobile device such as a mobile phone, a tablet, a laptop, or a netbook. The animation sequences can be created without any of the disadvantages of traditional animation or armature system techniques, such as high memory requirements, high processor power requirements, and limited degrees of creative freedom. The systems, devices, and methods for creating animation sequences can allow for reduced memory requirements and processing power requirements as compared to traditional animation techniques. In addition, the system, devices, and methods for creating animation sequences can allow for the creation of natural-looking animations due to the high degree of creative freedom.

One particular advantage of the systems, devices, and methods described herein for displaying animations is that they can reduce memory and processing burden on a rendering platform by allowing the animator to create complex animations through the use of stored media, including images and sound, metadata, and a scene graph of nodes. The scene graph of nodes can include transformations that manipulate the stored images to create new images that are created by calculations performed by the rendering platform. The new images can augment the range of images that can be displayed using a given set of stored images. The transformations, which can be affine transformations, can be readily performed by the rendering platform without significantly burdening the processing power of the rendering platform. This can allow the animator to balance the memory and processing requirements for a particular animation sequence because the animator can elect to display a selected image by storing that image in memory or by transforming another image.

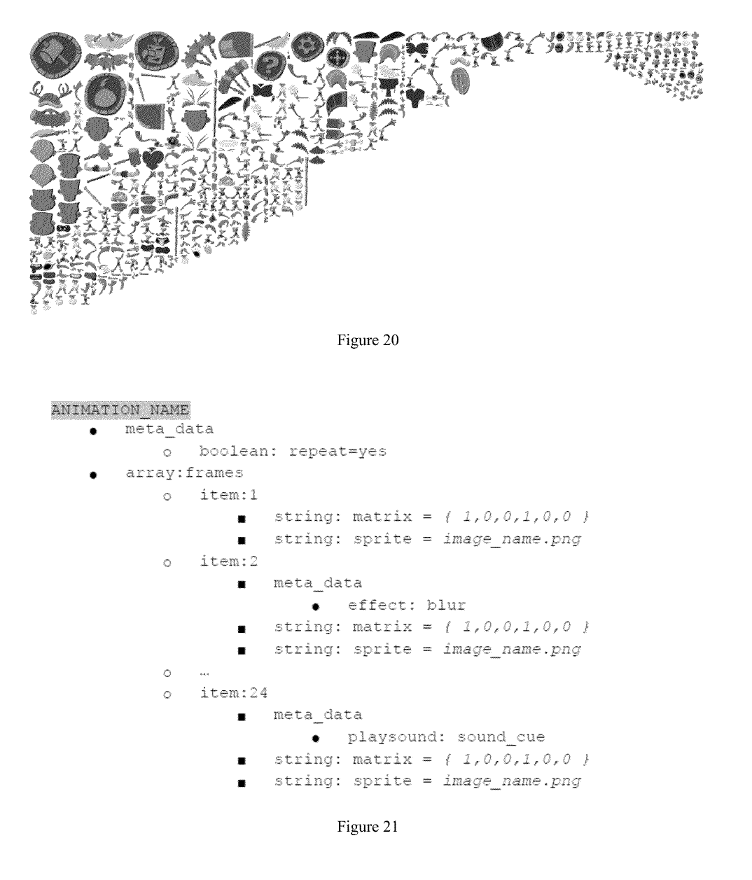

Another particular advantage of the systems, devices, and methods described herein for displaying animations is that they can reduce the memory requirements for storing images associated with an animation sequence by merging one or more animation sequences, removing duplicate images, and exporting the images in a single compact file, as shown in FIG. 16 and FIG. 20.

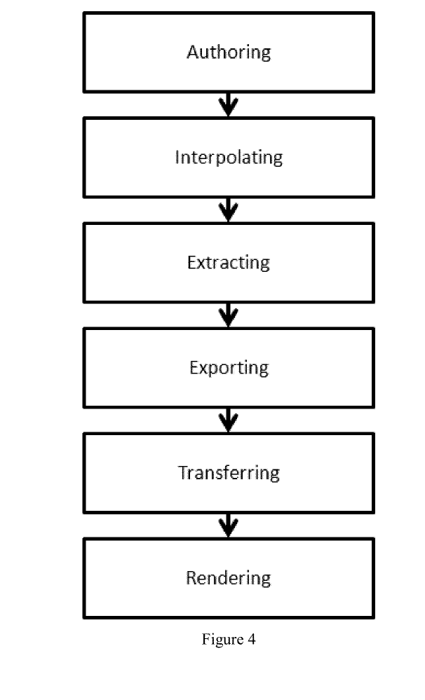

As shown in FIG. 4, a process for creating and displaying an animation on a device can include the following steps (a) authoring, (b) interpolating, (c) extracting, (d) exporting, (e) transferring, and (f) rendering. The authoring step can be performed on a variety of devices, such as a computer. The computer can have one or more tools that allow an artist to create the animation sequence. For example, an artist can use Adobe Flash Professional. The interpolating step can be performed after the animation is designed. The interpolating step can comprise calculating transformations on animation symbols or images that modify key frames. The key frames can be images of symbols or parts that an artist has created. The extracting step can include processing the frames of the animation sequence and storing one or more data types. The data types can include hierarchy, animation, and collection data. The exporting step can include packaging the extracted data into animation data files and associated images into a sprite sheet. The animation data files can be an xml dictionary that includes the hierarchy, animation, and collection data. The sprite sheet can include images of individual symbols that can be used to create the animations. A symbol lookup index may also be exported with the sprite sheet.

The process of creating and displaying an animation sequence can also include a transferring step. The transferring step can include transferring the animation data file, the sprite sheet, and the symbol lookup index to a rendering platform, such as a mobile device. The transferring step can be via an intermediary to an end user. The display process can also include a rendering step, where the animation data is processed by the rendering platform and displayed.

The animations can be animations of two-dimensional objects. Restricting the animations to animations of two-dimensional objects can allow for optimized performance on devices with low-memory capacity or low-processing power. Animation of two-dimensional objects can eliminate the need for complex meshes or models to display an animation sequence. This advantageously allows for animation sequences to be developed more easily, at a faster rate, and without knowledge of complex three-dimensional animation techniques. Two-dimensional animation sequences can be created using less processing power. The reduction on processing power requirements can be about or greater than about 10, 20, 50, or 75%. The processing power capability of a system for developing an animation can be measured using any standard known in the art. The relative power requirements can be determined based on the standard, or based on a cycle rate for the processor. Two-dimensional animation can also allow for the use of traditional animation techniques, which may be augmented as described herein. The two-dimensional objects can be objects that are flat and/or do not have a perspective. The process of creating an animation can be simplified such that minimal technical knowledge about product builds will be required.

The animations may be created on a variety of animation authoring platforms. In some embodiments, the animation authoring platform is Adobe Flash Professional. In other embodiments, the authoring platform is 3D Studio Max, Maya, or Corel Draw. However, the authoring tool can be any 2D animation tool, or combination of tools. The animation authoring platform can be capable of allowing animations to be exported into custom data formats, which may be tailored to the system that renders the animation. The animation authoring platform can support vector art asset creation. Vector art can include the use of geometrical primitives such as points, lines, curves, and shapes or polygons that are based on mathematical expressions to represent images. The asset creation can be created as symbols. The vector act can be exported in a PNG file format.

In some embodiments, the animation authoring platform can support the creation of scene graphs, including scene graphs that have parent-child layers. The authoring platform can allow each layer to be named and it can allow for plain text to be added to one or more layers. The plain text can be used to store metadata.

In other embodiments, the animation authoring platform can allow for key frame animation of symbols or parts. The key frames can be modified using affine transforms or any other number of modification tools known in the art.

The animation represented by a series of affine transforms and textures can be further preprocessed into a series of vertices. The preprocessing into vertices can be performed by the rendering platform or otherwise. Vertices or vertex arrays can be a data format used directly by graphics cards to render images to the screen in what is often called a graphics pipeline. The vertices can be calculated for some or all of the animation frames. The provision of vertices to a processor, such as a graphics processor, for rendering can reduce the overall processing requirements or required processor time.

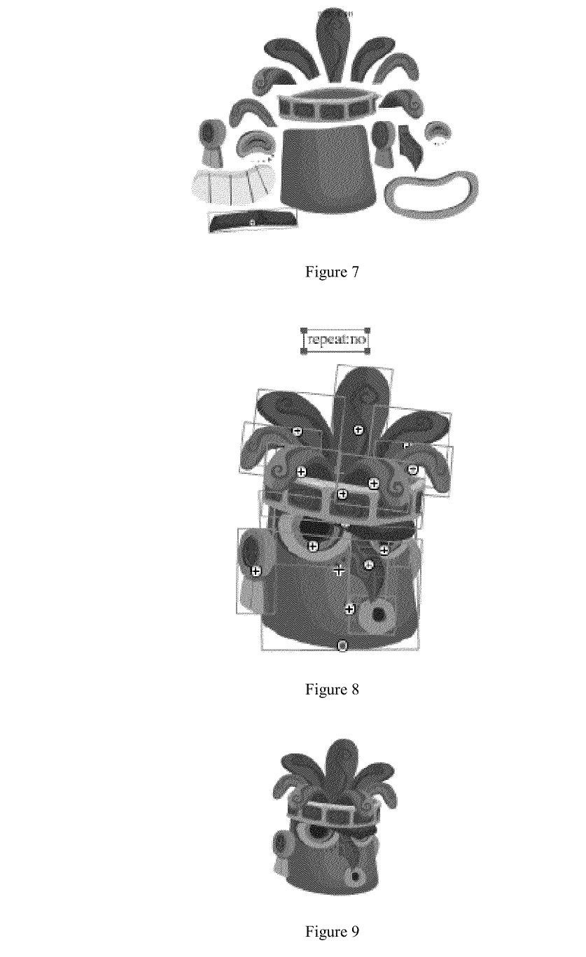

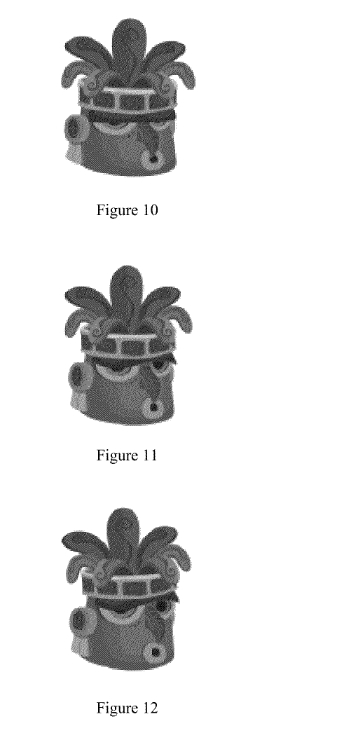

FIG. 6 shows an example of a face object that can be created using a plurality of parts or symbols. The parts or symbols can be created as vector art. FIG. 7 shows the individual parts that can be used to create the object. The parts include hair pieces, a head band, a face base, teeth, eyes, lips, nose, ears, and eye lashes. FIG. 8 shows the face with the individual pieces highlighted in a rectangle. A metadata tag is shown above the face indicates that the animation is not to be repeated. FIG. 9, FIG. 10, FIG. 11, and FIG. 12 show four frames in an animation sequence. The frames can be created by manipulating each individual part or symbol using affine transforms. Each frame can be defined through key frame transforms on each of the symbols. Use of multiple parts can allow multiple composite parts to create the look of traditional animation schemes while also achieving significant memory savings.

An animation sequence can be created as a scene graph of nodes. A scene graph can have a graph or tree structure. The scene graph can have one or more key frames. The nodes of the scene graph can represent a single image (an image node), an embedded scene graph (an embedded node), or a collection of nodes (a collection node). The nodes can be stored in memory on the rendering platform, such as a mobile device.

An image node can represents a single image and correspond to a particular frame of an animation. The image node can have one or more types of information or data associated with it, such as metadata, a reference to an image, and a transformation matrix, which may be an affine transformation matrix. The metadata can be stored in memory on the authoring platform and the rendering platform, such as a mobile device. A sequence of image nodes can be used to display an animation. In some embodiments, an image node can exclude information regarding perspective. The reference to an image can be a reference to an image of a 2D object that lacks perspective or is flat.

Affine transformations can preserve straight lines and ratios of distances between points on a straight line. For example, all points laying on a line initially can still lay on a line after transformation and the midpoint of a line segment can remain the midpoint after transformation. The affine transformation can allow for one or more manipulations, such as translation, skew, rotation, scaling, geometric contraction, expansion, reflection, shear, similarity transformation, and spiral transformation. These manipulations can be combined such that two or more manipulations are effected on the referenced image.

Image nodes may also include other transformations that can manipulate the referenced image. In some embodiments, non-affine transformations can be used to modify images. Other transformations include manipulations that cause changes in the objects color, brightness, and contrast.

In some embodiments, an animation sequence can comprise a sequence of image nodes. The image nodes can each refer to a single image file that will represent a particular object of an animation. Movement in the animation can be achieved through the use of affine transformations effected on the single referenced image file.

In other embodiments, an animation sequence can comprise a sequence of image nodes that reference more than image file that will represent a particular object of an animation. The use of more than one image file in the animation of an object can allow for a high degree of creative freedom. The high degree of creative freedom can be achieved because manipulations of the object are not constrained to affine transformations or other forms of transformations. For example, animation of a triangle to a square may be more optimally achieved using multiple images rather than a series of affine transformations. Accordingly, the invention provides for systems, devices, and methods that can allow for optimized display of animations with a high degree of control over the animation art.

A collection node can represent a collection of nodes that allows for an animation to render one or more of the collection nodes at runtime. A collection node can allow for interchangeable objects within an animation. For example, an animation of a person can have a collection node that corresponds to a variety of different outfits for that person. At runtime, one outfit of the collection of outfits can be selected for rendering. A collection node can be a group of other collection, image, or embedded nodes. In some embodiments, the nodes within a collection node are all image nodes.

An embedded node can represent an embedded child scene graph within a parent scene graph. The embedded node can be used to display sub-animations. A sub-animation can include animations within a parent animation that are specific to one region of the parent animation, or may span multiple regions of the parent animation. One or more image nodes, collection nodes, or embedded nodes can stem from an embedded node. The use of embedded nodes can allow for a high degree of freedom within an animation.

Use of embedded notes can increase the flexibility of how an animation is designed. Embedded nodes can allow for animations to be stored in parts, such that animations can be constructed from the parts at runtime. Embedded nodes can allow for nested hierarchies of separate animations within a scene graph, which is a significant advantage over existing armature or skeletal model techniques. Additionally, embedded nodes can allow for an existing animation or sets of animations to be updated without having to recreate the entire animation. Animation sequences can reference nodes across a plurality of hierarchies, for example an animation sequence can reference nodes that stem from two different root nodes.

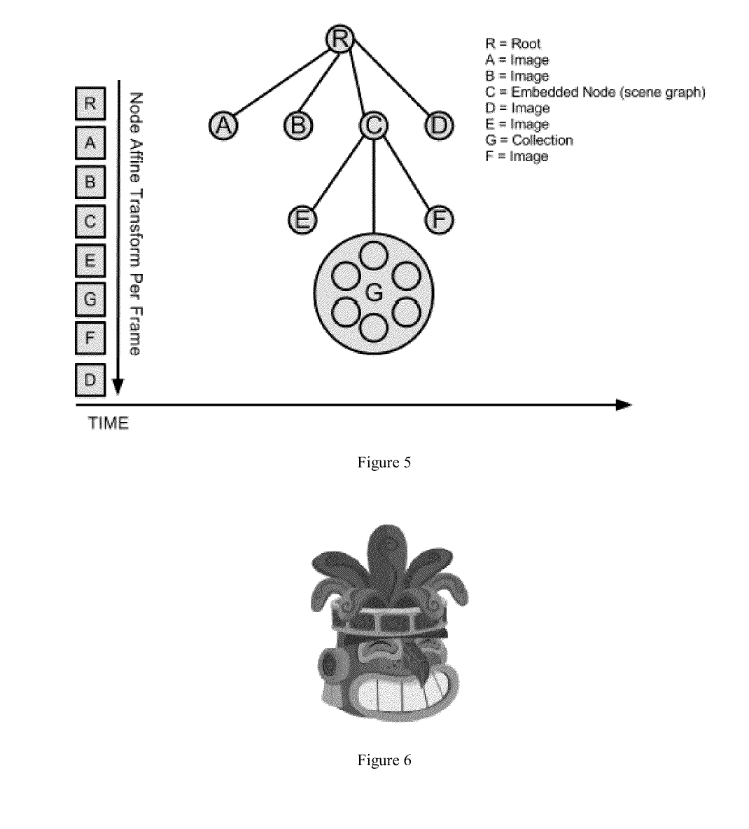

An example of a scene graph is shown in FIG. 5. The scene graph has a root, represented by R, having one or more dependent nodes. Nodes A, B, C, and D are directly dependent upon the root, where A, B, and D are image nodes. Node C is an embedded node that has multiple dependent nodes. Nodes E, F, and G are dependent upon C, where nodes E and F are additional image nodes. Node G is a collection node that represents a group of nodes.

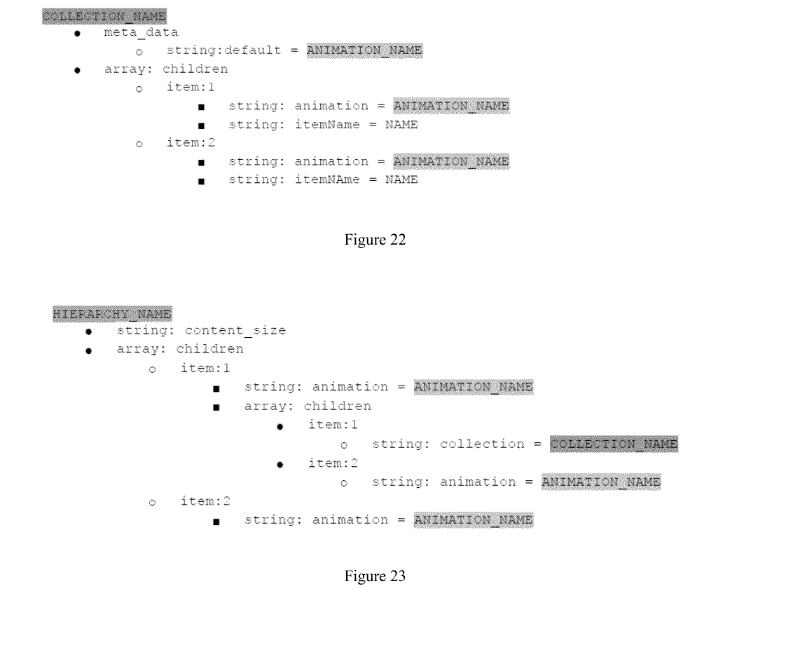

In some embodiments, the scene graphs can comprise metadata. Metadata can be associated with the scene graph nodes, such as image, collection, and embedded nodes. The metadata can be used to define custom actions. The metadata can be linked to particular nodes or objects at the animation authoring stage, or the metadata can be included in an animation data file that is exported from the animation authoring platform. The custom actions defined in the metadata can be processed at the time that the animation sequence is exported, or by the rendering platform, which may be at runtime. Customs actions that can be processed at the time of export include image manipulations, such as a blur effect, a tint effect, or an opacity effect. Custom actions that can be processed by the rendering platform, which may be at runtime, can allow for specific actions to be performed, such as the playback of one or more sounds or audio clips. The playback of sounds or audio clips can be synced with specific key frames of an animation. The custom actions that are processed by a rendering platform can be methods that have one or more parameters. The parameters can be used to implement logical actions that depend on one or more states of the runtime application. In some embodiments of the invention, metadata in an animation can be used to define collections. An example of a collection defined using metadata is shown in FIG. 22.

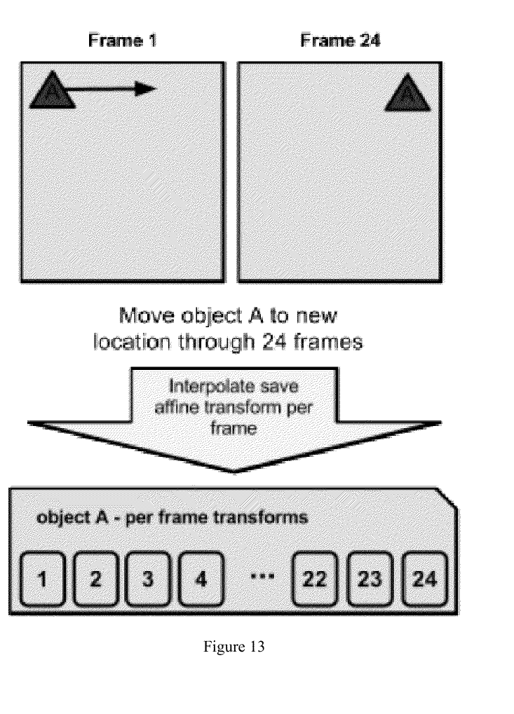

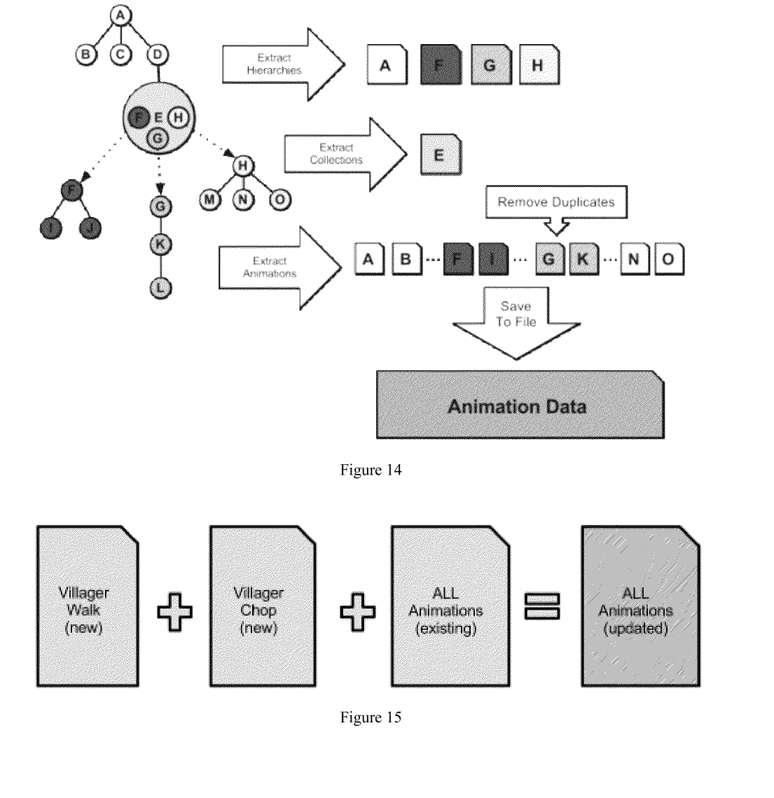

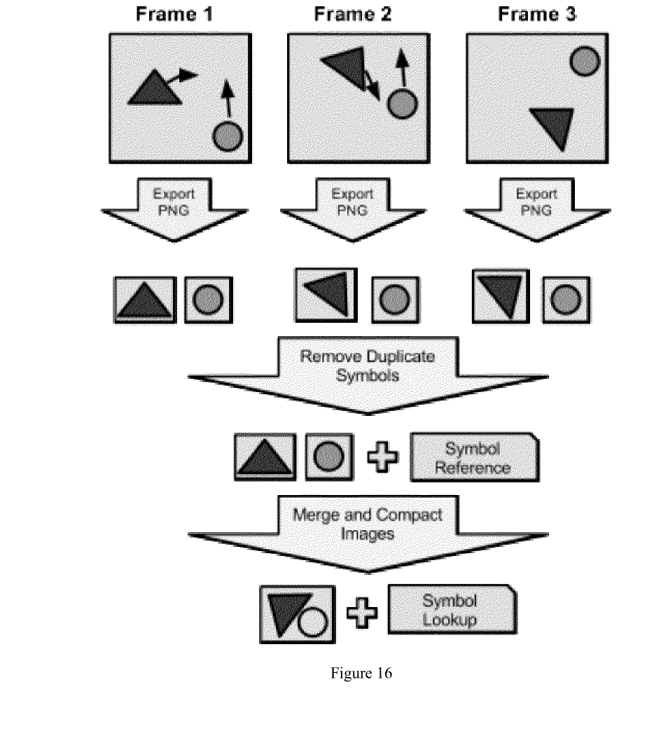

The invention also provides for system, devices, and methods for exporting animations. A diagram of an export process is shown in FIG. 13, FIG. 14, and FIG. 15. The animations can be exported to a rendering platform that can display the animations. In some embodiments, the animations are exported in the form of an animation data file and a corresponding sprite sheet. The exporting process can apply one or more effects noted in metadata information that accompanies the animation.

The export process can include one or more steps. In some embodiments, the export process includes recursively traversing a scene graph and interpolating the positions for all nodes in each frame. As shown in FIG. 13, object A is evaluated for frames 1 through 24. For each frame, the object is interpolated and an affine transformation is saved for each frame. This generates a series of transforms (24 of them) that are associated with object A for the 24 frame animation sequence. For each frame in an animation, the each specific node (image node) is exported. As shown in FIG. 14, the scene graph is traversed, where hierarchies, collections, and animations are each extracted. For each collection node, the nodes are evaluated such that all image nodes are also traversed and appropriate nodes are exported.

In some embodiments, the interpolated frame positions are calculated and affine transformations are saved and later exported to an animation data file. The generation and export of affine transformations to animation data files can reduce the processing power requirements on the rendering platform, as compared to skeletal animation techniques, because the rendering platform does not need to calculate interpolations for each frame at runtime. The processing requirements or processing time required to display an animation created with pre-calculated affine transformations can be reduced by about or greater than about 10, 20, 50, or 75%. The matrix transforms for manipulating individual symbols can be readily handled by standard graphics chips known in the art.

As shown in FIG. 14, an optimization pass during the export process can be used to remove duplicate animations. The optimization pass can remove duplicate frames and loop single frame animations for the duration of the duplication. The optimization pass can include the generation of md5 hashes of the animation data, which can allow reuse of previous animation data if a match is found.

Continuing with FIG. 14, the export process can also include the generation of an animation data file. The animation data file can include hierarchy data, animation data, and collection data.

As shown in FIG. 15, the animation export process can also include a merge process that aggregates animation data across multiple animation data files into a single animation data file. The process can include storing hierarchy, collection, and animation data from multiple animation data files and overwriting existing data. The existing data can be from animation data files that were previously generated, and pre-existing data can be overwritten with new animation data from newly generated animations. The cumulative data can then be stored in a single updated animation data file.

The flexibility of the system can allow for updates to any node of an existing animation without having to recreate the entire hierarchy. This can allow for flexible servicing and update options because updates can be data driven and do not require the product to be rebuilt. Furthermore, updated sprite sheets that require only a single sprite sheet can avoid sprite sheet limitations of rendering platforms, such as a mobile device. The limitation on sprite sheets can be because of memory capacity requirements, or other requirements known in the art.

The invention also provides for the creation of sprite sheets. The sprites sheets generated using the systems, devices, and methods described herein can have significant lower memory footprints as compared to traditional sprite sheets. These sprite sheets for animations can have a memory footprint that is about, or less than about 5, 10, 20, 50, or 75% of the memory footprint of a traditional sprite sheet for an substantially equivalent animation created using traditional animation techniques. FIG. 16 shows an example of a sprite sheet generation process. As shown in FIG. 16, objects in a plurality of frames can be exported as image files. The objects can be modified using any metadata tags that are processed at the time of export, such as a blur effect. If an object is to be modified with an effect, the object with the effect can also be exported. The image files may be PNG files. The sprite sheet generation process can recognize and remove duplicate symbols. A symbol reference can also be generated for each symbol. Once the unique symbols are exported and the symbol references are created, they can be merged and compacted into a single sprite sheet and corresponding symbol lookup index. An example of a compacted sprite sheet is shown in FIG. 20. The symbol lookup index can be utilized at runtime by the rendering platform to identify the proper symbol to display. The arrangement of images in the single sprite sheet can be an efficient arrangement that minimizes file size. The single sprite sheet and symbol lookup index can eliminate the need for multiple sprite sheets.

In accordance with the invention, animation data (which can include the animation data files, corresponding sprite sheets, and symbol lookup index) can include information required to reconstruct one or more animations on a rendering platform, such as a mobile device. The animation data can be a fraction of the size of a traditional animation sprite sheet, yet contain 10, 50, 100, or 1000 more animations than a traditional animation sprite sheet. An example of a traditional sprite sheet is shown in FIG. 19. FIG. 19 shows a sprite sheet for a single villager face combination using one tool and performing three actions. In comparison, FIG. 20 shows a compacted sprite sheet with parts that can be used to create multiple village faces with various hats, and tools to perform multiple actions. The compacted sprite sheet can create over 2 million combinations.

The animation data file can store a scene graph of an animation as an xml dictionary. The animation data file can have one or more sections. In some embodiments, the animation data file has an animation section, a collection section, and a hierarchy section. An example of an animation section is shown in FIG. 21.

The animation section can contain key frame information about the animation. The data structure can be a sequence of affine transforms per frame that are applied to an individual image. As shown in FIG. 21, the animation section can include metadata portion and a frame array portion. The metadata portion can indicate whether the animation is to be repeated. The frame array portion can include a sequence of frames, here indicated as item 1, 2 . . . 24. Each frame can include metadata information and one or more strings. As shown in item 2 of FIG. 21, the metadata can enumerate one or more effects, such as blur, that are processed upon export of the animation. The strings can include a matrix field that indicates a corresponding affine transformation and a sprite field that indicates a referenced image file name.

The collection section can include sets of animations defined for a collection. The collection section can contain an array of child nodes of animations in the collection. As shown in FIG. 22, the collection section can include metadata and a children array. The metadata can define the name of a default animation collection. The children array can include one or more collections. In FIG. 22, a first collection is listed under item 1, and a second collection is listed under item 2.

The hierarchy section can include a scene graph of nodes that comprises animations and/or collections. The hierarchy section can include the content size and an array of child nodes. As shown in FIG. 23, the hierarchy section can include a content size portion and a children array section. The content size portion can indicate the size of the content. The children array portion can define one or more nodes. Nodes within the children array portion can also define other children of nodes. An example of this is shown in item 1 of FIG. 23, which includes a sub-children array of two items, the first of which is a collection node, and the second of which is an animation node.

The invention also provides for systems, devices, and methods for displaying animations. The animation display process can include (1) loading animation data, (2) deserializing hierarchies, collections, and animations into dictionaries, (3) processing metadata and collection defaults, (4) creating a scene graph from the hierarchy, (5) loading the scene graph into a rendering engine, and (6) playing the animation. The process for importing assets (art, animations, sound, and music) into a runtime engine can be referred to as asset integration. The runtime engine can be a component of an application that consumes animation data files and renders the animations on a target platform. The process of playing or rendering the animation can include (a) processing metadata in the current frame, (b) updating the scene graph nodes if necessary based on execution logic, (c) executing callbacks based on one or more metadata definitions, (d) rendering the scene graph, and (e) loading the next frame and returning to step (a).

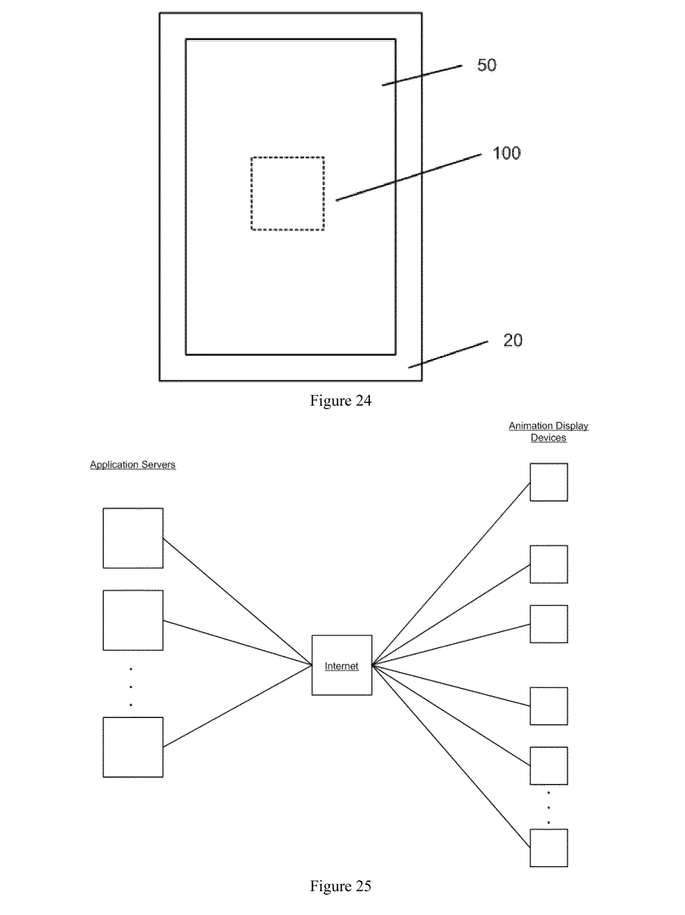

The rendering platform can be a device with low-memory capacity and/or low-processing capacity. FIG. 24 shows an example of a device (20) for displaying an animation sequence. The device can have a display screen (50) that can display an animation sequence. The device can include a processor (100) that can process the animation sequence information and provide rendering instructions to the screen. Exemplary devices include mobile devices such as a mobile phones, tablets, laptops, and netbooks. In some embodiments, the animations can be displayed on a device that utilizes the Apple iOS operating system, such as an iPhone or an iPad. In other embodiments, the animations can be displayed in an Android device, a Windows Phone device, such as a Windows Phone 7 device, or a Blackberry device.

An exemplary system for displaying animation is shown in FIG. 25. As shown in FIG. 25, the system can include one or more animation devices that are connected to one or more application servers via the Internet. The one or more application servers can transfer data to the or more devices for displaying animations, wherein the data comprises animation sequence data, as described herein.

### EXAMPLES

### Example 1

### Generation of Custom Animations

The animation systems described herein can allow the flexibility to create rich sets of animations for small memory devices. The hierarchy system with the ability to swap out nodes and collections gives the freedom to define complex nested combinations of animations. In Table 1 below, the system is currently used to create the animation set for a unique set of male and female villager characters (with swappable facial features) that can be equipped with different items and tools.

TABLE 1

| Animation | Collection Name | Variations | Total Combinations |
|---|---|---|---|
| Male Villager Unique Faces | Male Face Shape | 5 | |
| | Male Eyes | 5 | |
| | Male Nose | 5 | |
| | Male Hair | 5 | |
| | Male Mouth | 5 | |
| Male Villager Face Total | | 5 × 5 × 5 × 5 × 5 | 3125 |
| Female Villager Unique Faces | Female Face Shape | 5 | |
| | Female Eyes | 5 | |
| | Female Nose | 5 | |
| | Female Hair | 5 | |
| | Female Mouth | 5 | |
| Female Villager Face Total | | 5 × 5 × 5 × 5 × 5 | 3125 |
| Unisex Tools | Building, Mining, Wood, etc | 16 | |
| Unisex Decorative Items | Hats, Earrings, etc | 16 | |
| Unisex Specialized Building | Farm, Joose Hut, Etc | 5 | |
| Male Animations with Tools and Items | Male × Tools × Decorative | 3125 × 16 × 16 | 800,000 |
| Female Animations with Tools and Items | Female × Tools × Decorative | 3125 × 16 × 16 | 800,000 |
| Male Specialized Building | Male × Decor, × Specialized | 3125 × 16 × 5 | 250,000 |
| Female Specialized Building | Male × Decor, × Specialized | 3125 × 16 × 5 | 250,000 |
| Total Male | All Male + Specialized | 800k + 250k | 1,050,000 |
| Total Female | All Female + Specialized | 800k + 250k | 1,050,000 |
| Total Animations | Total Male + Total Female | 1.05 m + 1.05 m | 2,100,000 |

The table above lists the possible number of combinations of animations that can be achieved with a fixed number of collections, however there is the potential to grow the number of combinations to a greater magnitude as the system supports dynamic updates to any node in the hierarchy. This gives the freedom to release content updates to create a richer set of facial features, tools and items without having to modify the existing animations.

### Example 2

### Sample Male and Female Face Combinations

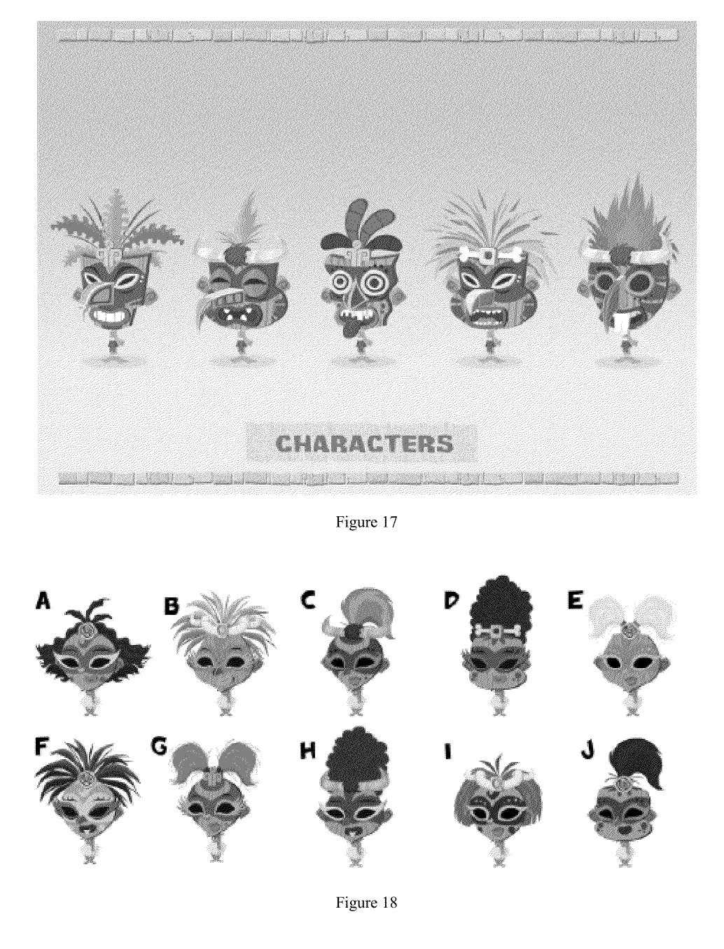

FIG. 17 shows sample male face combinations. In the sample, there are 5 different hair combinations, 5 different eye combinations, 5 different noses, 5 different mouths, 5 different head pieces, 5 different face shapes. All the variations make a possible combination of 15,625 unique faces. New facial features can be released as an update or as downloadable content.

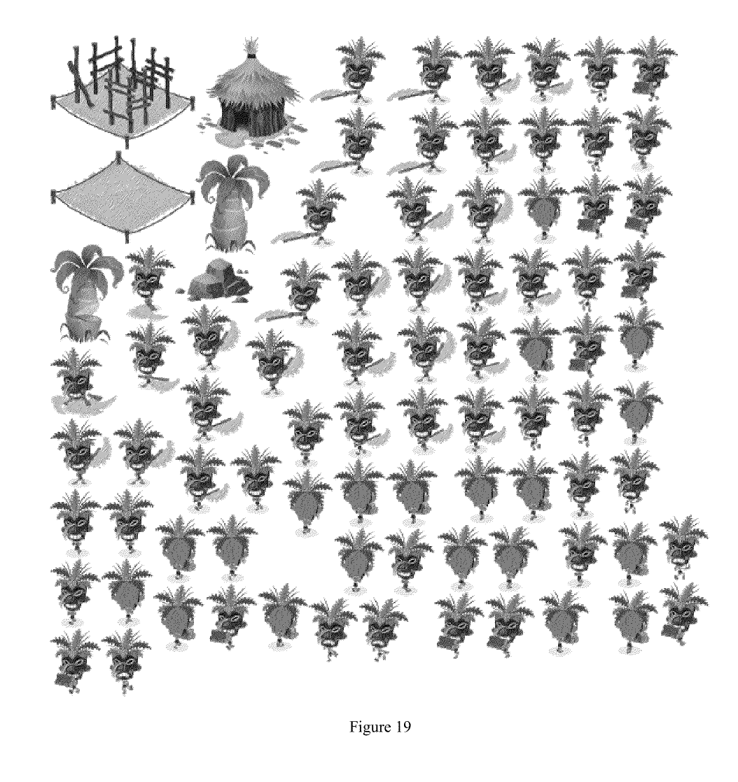

FIG. 18 shows sample female face combinations. In the sample below there are 4 different face shapes, 6 hair styles, 5 eye combinations, 6 mouth combinations, 5 head pieces and 5 different noses. All variations make a possible combination of 18,000 faces.

### Example 3

### Sample Animation Data File

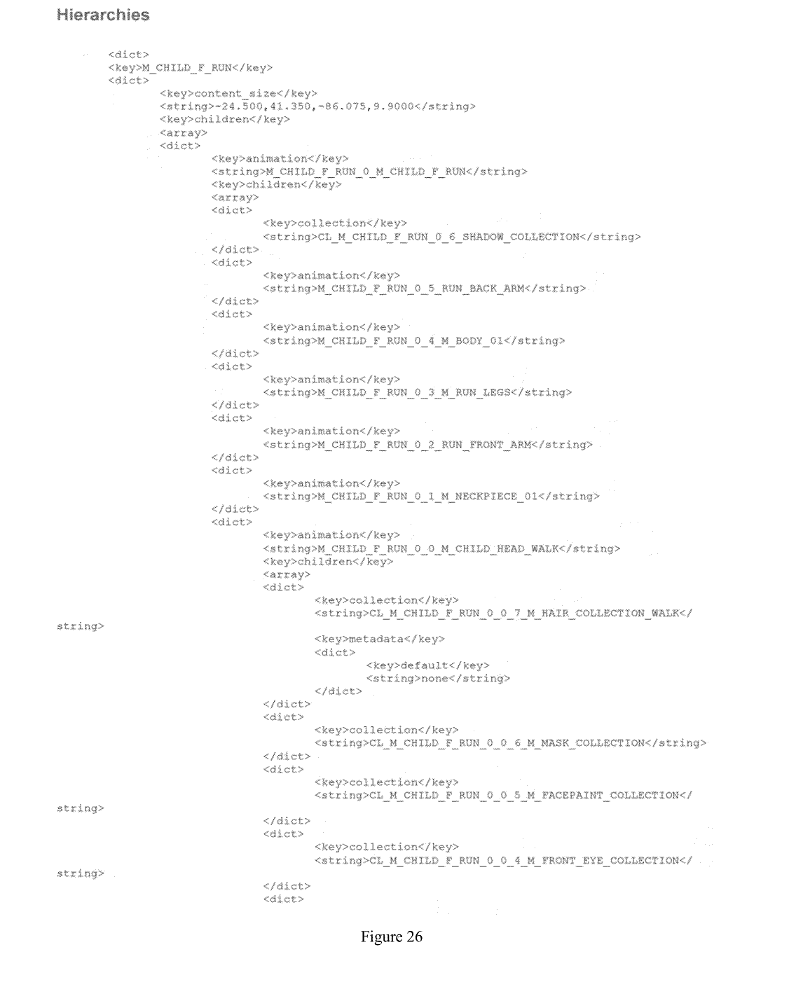

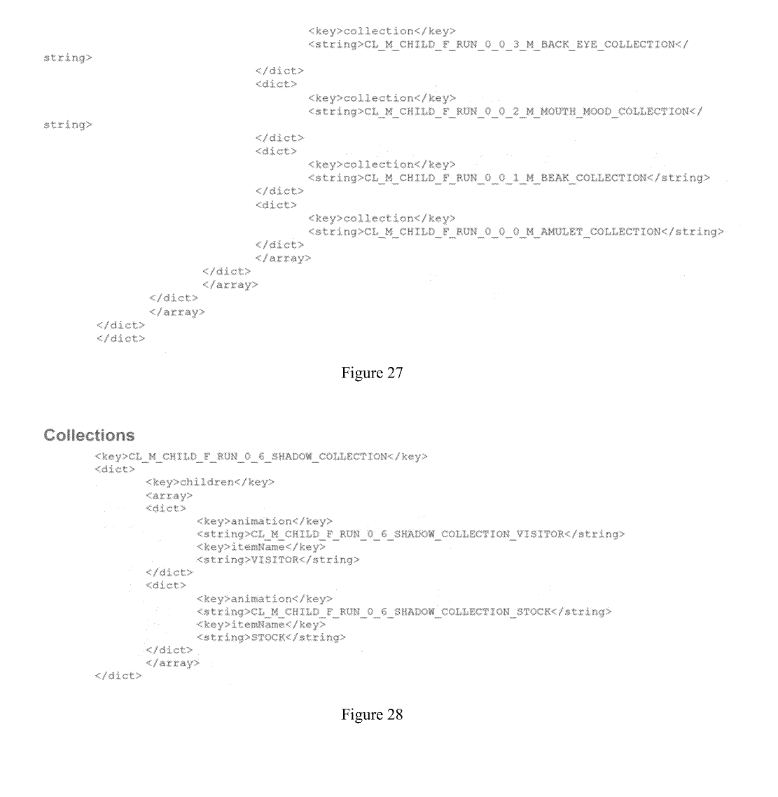

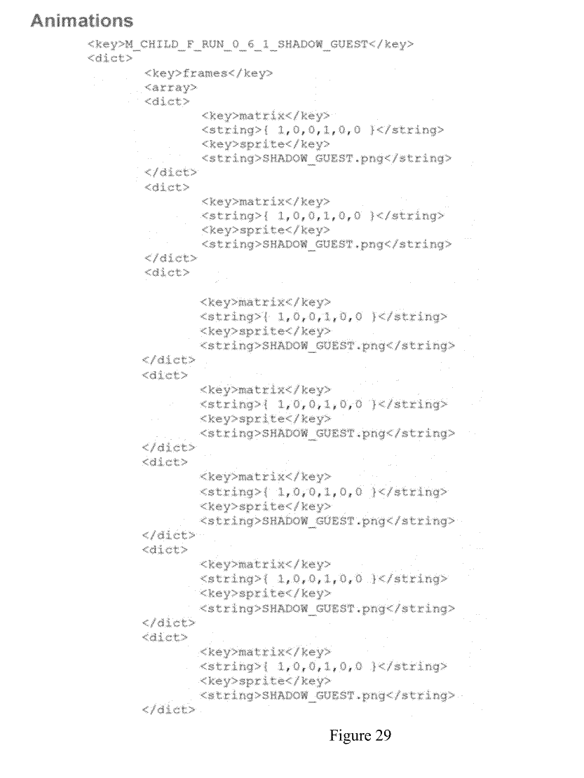

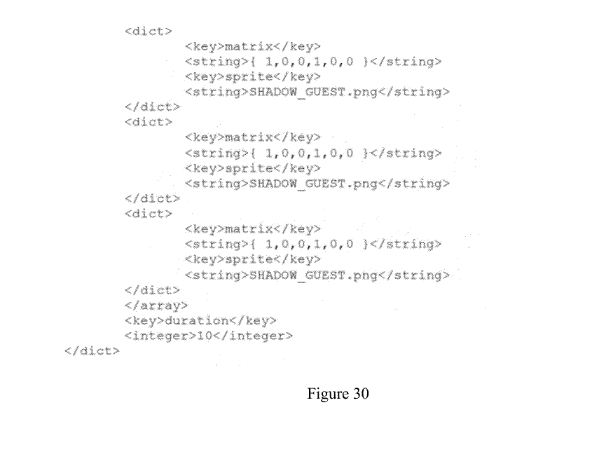

FIG. 26, FIG. 27, FIG. 28, FIG. 29, and FIG. 30 show parts 1, 2, 3, 4, and 5 of an exemplary animation data file. The animation data file includes a hierarchies section, a collections section, and an animations section. A hierarchies section is shown in FIG. 26 and FIG. 27. The hierarchies section includes a hierarchy for an animation of a child running, which includes a portion to indicate content size. The children array portion of the hierarchies section defines multiple nodes, which can be collection, embedded, or image nodes. FIG. 28 shows the collections section of the animation data file. The collections section includes a children array which defines multiple collections. FIG. 29 and FIG. 30 show the animations section of the animation data file. The animations section includes a frames array that defines the plurality of frames in an animation sequence. Each frame defines a transform matrix and references an image file.

### Example 4

### Animation Systems Having Reduced Memory and Processing Requirements

As described in Example 1, the animation systems described herein can utilize a hierarchy system with nodes and collections that allow an animator to create complex animations using a limited amount of resources on a rendering platform, such as a mobile device. The hierarchy system with nodes and collections allows an animator to utilize transformations to display new images to be calculated by the rendering platform from stored images. The transformations and calculations can be such that they are readily performed by the rendering platform and do not overly burden the rendering platform. The hierarchy system with nodes and collections also allows, if the animator elects, for new images to be displayed from a stored image rather than utilize a transformation of another image. In this case, the processing requirements will be reduced, but the memory storage requirements may be increased. This optionally can allow for an animator, or an automated system or authoring platform, to achieve a desired balance of memory and processor burden on the rendering platform.

By way of example, an animator can desire to display an animation sequence of a character that can have a range of hair styles. The hair styles can include a mohawk hair style, a pigtail hair style, a left-side parted hair style, and a right-side parted hair style. To create an efficient animation sequence that has reduced memory and processing requirements, the animator can elect to store key images associated with the mohawk, pigtail, and the left-side parted hairstyles. The animator can further create the right-side parted hairstyle by performing a mirror image transformation on the key image or images for the left-side parted hairstyle. If the animator would rather reduce the processing burden on the rendering platform, the animator could instead elect to store key images for both the left and right-side parted hairstyles.

If the animator then desires to add additional hairstyles, such as the pigtail with a shape variation, the animator can again choose to either use a transformation of the previously stored pigtail key image or images, or the animator can store additional key images for the new pigtail hairstyle. The decision to utilize a transformation or store a new key image can be based on an analysis of the processing and memory requirements associated with each option, thus allowing for the animator to achieve a desired balance of processing and memory requirements for the display of animation sequences.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method for creating a two-dimensional animation sequence for display on a mobile device comprising:
creating the animation sequence for viewing on a display screen of the mobile device comprising a plurality of nodes and metadata that are each stored in memory,
wherein each node of the plurality of nodes is either an image node, an embedded node, or a collection node, and
wherein each image node of the plurality of nodes further comprises a transform matrix and a reference to an image file.

2. The method of claim 1, wherein the transform matrix comprises an affine transform matrix.

3. The method of claim 1, further comprising:
creating an animation data file for processing by a processor of the mobile device that comprises hierarchy data, collection data, and animation data, wherein the hierarchy data comprises a scene graph of the plurality of nodes,
wherein the collection data comprises collection node data having a plurality of animation sets, and
wherein the animation data comprises image node data.

4. The method of claim 3, further comprising transferring the animation data to the processor of the mobile device for rendering of the animation sequence on the display of the mobile device.

5. The method of claim 4, further comprising calculating one or more vertices for rendering the animation sequence on the display of the mobile device.

6. The method of claim 2, wherein the animation data file is an xml dictionary.

7. The method of claim 1, wherein the image node comprises a reference to an image file of a two-dimensional object.

8. The method of claim 1, further comprising:
creating a sprite sheet that comprises a compilation of each image file referenced by each image node of the plurality of nodes.

9. The method of claim 8, wherein the sprite sheet does not include duplicate images.

10. The method of claim 1, wherein the plurality of nodes comprises at least one image node, at least one embedded node, and at least one collection node.

11. The method of claim 1, wherein the plurality of nodes comprises an embedded node, and wherein the embedded node represents a child scene graph.

12. The method of claim 1, wherein the plurality of nodes comprises a collection node, and wherein the collection node represents a collection of nodes, one of which is selected for rendering at runtime.

13. The method of claim 1, wherein the metadata comprises instructions interpreted by an animation exporter.

14. The method of claim 13, wherein the instructions interpreted by the animation exporter cause a blur effect on an image referenced by at least one image node of the plurality of nodes, and wherein the image with the blur effect is exported.

15. The method of claim 1, wherein the metadata comprises instructions interpreted by the mobile device.

16. The method of claim 15, wherein the instructions interpreted by the mobile device include instructions to play a sound.

17. The method of claim 15, wherein the instructions interpreted by the mobile device include instructions to repeat the animation.

18. The method of claim 1, wherein each image file referenced by each image node of the plurality of nodes comprises an image of a two-dimensional object.

19. A method for creating a two-dimensional animation sequence for display on a mobile device comprising:
creating the animation sequence comprising a scene graph of a plurality of nodes that are stored in memory, wherein each node of the plurality of nodes is either an image node, an embedded node, or a collection node;
extracting hierarchy data, collection data, and animation data from the scene graph,
wherein the hierarchy data comprises information that represents the structure of the scene graph,
wherein the collection data comprises information that represents multiple interchangeable animation sets, and
wherein the animation data comprises information that represents individual frames of the animation sequence; and
saving the hierarchy data, the collection data, and the animation data to an animation data file.

20. The method of claim 19, wherein each image node of the plurality of nodes comprises an affine transformation matrix and a reference to an image file.

21. The method of claim 20, further comprising:
creating a sprite sheet that comprises each image referenced by each image node.

22. The method of claim 19, wherein the animation sequence comprises metadata, and wherein the metadata is interpreted either by an animation exporter or by the mobile device.

23. A method for creating a two-dimensional animation sequence for display on a mobile device comprising:
creating a sequence of images comprising a plurality of first images and plurality of second images that are transformations of the first images;
calculating a plurality of transformation matrices between the plurality of first images and the plurality of second images;
exporting the transformation matrices and references to the plurality of first images to an animation data file that is stored in memory; and
creating a sprite sheet comprising the plurality of first images,
wherein the sprite sheet excludes duplicate first images.

24. The method of claim 23, wherein the transformations comprise affine transformations and the transformation matrices comprise affine transformation matrices.

25. The method of claim 23, wherein the plurality of second images are interpolations between the first image and a final image.

26. The method of claim 23, wherein the animation data file comprises hierarchy data, animation data, and collection data in an xml dictionary.

27. The method of claim 23, wherein the plurality of first images and the plurality of second images are images of two-dimensional objects.
